(19) United States
(12) Patent Application Publication
(10) Pub. No.: US 2010/0177110 A1
(43) Pub. Date: Jul. 15, 2010

(54) METHOD OF FAST COLORING A POLYGON

(76) Inventor: Wei-Yu LAI, Taoyuan Shien (TW)

Correspondence Address: HDLS Patent & Trademark Services, P.O. BOX 220746, CHANTILLY, VA, 20153-0746, US

(21) Appl. No.: 12/351,995

(22) Filed: Jan. 12, 2009

(51) Int. Cl. G09G 5/02

(52) U.S. Cl. 345/589

(57) ABSTRACT

A method of fast coloring a polygon for calculating areas of figures, the method comprising steps of resetting record values of all coordinate points to zero in the memory space; inputting the coordinate value of the ordered nodes defining the polygon into the memory space; connecting the nodes according to a predetermined order to determine connection points between the nodes; assigning a record value of each of the nodes as a flag value or a line value; assigning a record value of each of the connection points as a flag value or a line value; and calculating the area of the polygon by processing record values of the coordinate points in the memory space according to the record values of the nodes and the record values of the connection points. The method of fast coloring a polygon of the present invention is implemented with ordinary instead of complicated hardware configurations.

### BACKGROUND OF THE INVENTION

1. Field of the Invention

The present invention generally relates to a method of fast coloring, in particular, to method of fast coloring a polygon.

2. Description of Prior Art

In a digitized world, image processing has becoming a popular area along with the development of computer technologies. Image processing refers to the processing image data of images from digital cameras or from scanned photos taken by optical cameras. Similar to prior art optical processing in a dark room, computer applications are installed in a computer to process image data and generate desired image results. Such image processing applications are also called digital dark room, where users are allowed to receive desirable image results with simple procedures at a lower cost without the need to hide in the dark, have frequent contacts with chemical materials. More to that, image processing applications is advantageous in creating complicated image effects, providing massive duplications in hard copies, as well as directly applicable to printing, and convenient to distribute on the internet.

The technology for area calculating is a critical part of image processing technologies. Typically, image data is massive and large demand in computing capability and processing time. Under the limitation of cost and hardware process accelerating capacity, software can be an effective approach to increase the processing speed. The processing time of the conventional technology for area calculating is in effective in terms of time and required memory for image processing, which is not suited for implementing at the hardware level. Therefore, it is advantageous to an image process user by offering a rapid method of fast coloring a polygon via increasing calculating speed implemented with a resource limited hardware configuration such as human machine interface instead of complicated hardware configuration.

### SUMMARY OF THE INVENTION

Therefore it is an object of the present invention to provide a method to overcome the disadvantages of the aforementioned prior art such as limited calculation speed. The method according to the present invention can be implemented with ordinary hardware configuration instead of a complicated hardware configuration.

To realize the above object, the major steps of the method of fast coloring a polygon comprise: resetting record values of all coordinate points to zero in said memory space; inputting the coordinate value of said ordered nodes defining said polygon into the memory space; connecting said nodes according to a predetermined order to determine connection points between said nodes; assigning a record value of each of said nodes as a flag value or a line value; assigning a record value of each of said connection points as a flag value or a line value; and calculating said area of said polygon by processing record values of said coordinate points in said memory space according to said record values of said nodes and said record values of said connection points. The method for fast coloring a polygon according to the present invention can be implemented with ordinary hardware configuration instead of a complicated hardware configuration.

### DETAILED DESCRIPTION OF THE INVENTION

Drawings from FIG. 7 to FIG. 11 are perspective views illustrating embodiments using the method of fast coloring a polygon according to an embodiment of the present invention. The purpose of the method of fast coloring a polygon of the present invention is to calculate colored area of polygons shown from FIG. 7 to FIG. 11. The area of the polygons from FIG. 7 to FIG. 11 is defined by ordered nodes. The method of fast coloring a polygon of the present invention is further described in details in the following.

FIG. 1 is a flow chart of the method of fast coloring a polygon according to the present invention. First, the record values of all coordinate points in a memory space pattern (the size of the memory space is by R rows multiple by C columns) is reset to zero at step S10 so as to proceed to the following step. FIG. 12 is a perspective view illustrating the memory space according to the present invention. The memory space comprises matrix memorizing units a plurality of coordinate points (each record value representing a pixel). Given the memory space comprises coordinate points of C rows (at X axis)×R(at Y axis) columns, the coordinate points of the row varies as the index of a row varies. The following steps of the present invention adapt the means to process by rows, it should be noted that the means to process by columns are also applicable to an embodiment according to the scope of the present invention. More to that, the coordinate points increment follow the sequence from left to right at X axis and from top to bottom at Y axis in the memory space shown in the FIG. 12. In the FIG. 1, the coordinates of nodes of a polygon (N-sided shape) is input into the memory space as (X₁, Y₁) . . . (X_{N}, Y_{N}) at step S20. Following that, the nodes are connected by a predetermined order to determine the connection points between two nodes at step S30. For examples, node (X₁, Y₁) is connected to node (X₂, Y₂) and node (X₂, Y₂) is connected to node (X₃, Y₃) . . . till the last node (X_{N}, Y_{N}) is connected to the first node (X₁, Y₁). At step S40, the record value of each node is assigned as a flag value or a line value (described in the following). At step S50, the record value of connecting nodes is assigned as a flag value or a line value (described in the following). At step S60, calculate the area of the polygon by processing record values of the coordinate points in the memory space according to the record values of the nodes and the record values of the connection points (described in the following).

In the FIG. 4, each memory unit is called a coordinate point in the arrays of the memory space. The polygon is defined by a plurality of ordered nodes, which are labeled as points m, m+1. In addition, the coordinate points defined by the connected line between two nodes are called connection points for calculating the area of the polygon. The connection points are the points marked with shadowed background in the FIG. 4.

FIG. 2 is a flow chart of assigning a record value of each of the nodes as a flag value or a line value according to the present invention and used for describing details of that the record value of each node is assigned as a flag value or a line value at step S40. Given that the coordinates of the m node, the current node, under the process is (Xₘ, Yₘ), the coordinates of the previous node is (Xₘ₋₁, Yₘ₋₁), and the coordinates of the next node is (Xₘ₊₁, Yₘ₊₁). XY coordinates are the conventional XY coordinate system. If m node is the first node, then the coordinates for the precious node (Xₘ₋₁, Yₘ₋₁) of the first node is (X_{N}, Y_{N}). At step S420, the method determines if the current node, the precious node and the next node form a reflection by the following conditions:

(Yₘ>=Yₘ₊₁ and Yₘ<Yₘ₋₁) (1)

(Yₘ<Yₘ₊₁ and Yₘ>=Yₘ₋₁) (2)

Given that either of the above conditions is true, that means the current node, the precious node and the next node does not form a reflection. The method moves to step S440 to assign the record value of the current node (Xₘ, Yₘ) as a flag value. If not true, that means the precious node and the next node form a reflection. The method moves to step S460 to assign the record value of the current node (Xₘ, Yₘ) as a line value. The flow of the node process characteristics can be expressed in the program language as the following:

```
  if((Yₘ >= Yₘ₊₁ and Yₘ < Yₘ₋₁) or (Yₘ < Yₘ₊₁ and Yₘ >= Yₘ₋₁))
{
  Pattern[Xₘ][Yₘ] := FLAG;
}
else
{
  Pattern[Xₘ][Yₘ] := LINE;
}
```

FIG. 3 is a flow chart of assigning a record value of each of the connection points between two nodes as a flag value or a line value according to the present invention and used for describing details of that the record value of each connection point is assigned as a flag value or a line value at step S50. In other words, the method processes the record value of the connection point at the connected line between the current node and the next node (Xₘ₊₁, Yₘ₊₁). First, at step S510, the method determines if the coordinate Ym of the current node does not equals to the coordinate Yₘ₊₁ of the next node. If not true, that means the row coordinate Ym equals to the row coordinate Yₘ₊₁, the method moves to step S590 and terminates the process. If true, that means the current node and the next node is not in the same row, the method moves to step S520 to determine if the row coordinate Ym is more than the row coordinate Yₘ₋₁. If true, the method moves to step S530 to process the (Yₘ)−1 row to the (Yₘ₋₁)+1 row. If not true, then the method moves to step S540 to process the (Yₘ₊₁)−1 row to the (Yₘ)+1 row. The purpose of the above flow is to process the record value of the connection point on the connected line between the node (Xₘ, Yₘ) and the node (Xₘ₊₁, Yₘ₊₁), but not including the nodes (Xₘ, Yₘ) and (Xₘ₊₁, Yₘ₊₁). Then at step S550, the method determines if the record value of the first connection point of the next row is a flag value. In other words, if the connection point between (Xₘ, Yₘ) and (Xₘ₊₁, Yₘ₊₁) of the next row, which is the record value of the first connection point of the next row, is a flag value. If true, then the method moves to step S560 to assign the record value of the first connection point of the next row is a line value. If not true, the method moves to step S570 to assign the record value of the first connection point of the next row as a flag value. The purpose of the flow is to assign the record value of the first connection point of the next row as a flag value. However, if the record value of the first connection point of the next row is found already a flag value, then the method change the record value of the first connection point of the next row as a line value. At step S580, the method assigns the record values of the rest of the connection points of the next row as line values. If every connection point between two nodes of the polygon is processed by the steps demonstrated in the FIG. 3, the result is equivalent to the result after performing the step S50 demonstrated in the FIG. 1, the step to assign record values of connection points.

FIG. 4 is a perspective view illustrating assigning a record value of each of the connection points as a flag value or a line value according to an embodiment of the present invention and used for giving further details of the above process. Each section shown in the drawing represents a location of the memory, where the characteristics of the connection points between node (Xₘ, Yₘ) and node (Xₘ₊₁, Yₘ₊₁) is determined. In the FIG. 4, notion m represents node (Xₘ, Yₘ), notion m+1 represents node (Xₘ₊₁, Yₘ₊₁), notion F represents a flag value, and notion L represents a line value. As shown in the drawing, the record value of the first connection point of the connection points on the connected line between (Xₘ, Yₘ) to (Xₘ₊₁, Yₘ₊₁) of the next row is assigned as a flag value F, and the record values of the rest of the connection points are assigned as line value L.

FIG. 5 is a perspective view illustrating assigning a record value of each of the connection points as a flag value or a line value according to another embodiment of the present invention. The purpose of the drawing is to illustrate that the record value of the first connection point of the next row is assigned as a line value at step S560. The details are described in the flow used in the FIG. 4. It should be noted that the record value of the first connection point of the fourth row is a flag value F in the FIG. 4. Nonetheless, the record value of the first connection point of the next row is a flag value at step S550 in the FIG. 5, the method moves to step S560 to assign the record value of the first connection point of the next row as a line value L, which is different from the record value of the first connection point of the next row.

After the above flow of assigning the record value of the connection points between the nodes as a flag value or a line value, the method move to calculate the area formed by the lines connected between nodes by a predetermined order (i.e. the colored area of the polygons from FIG. 7 to FIG. 11). FIG. 6 is a flow chart of processing the record values of a row of the polygon according to the present invention and used for describing in details of calculating the area of the polygon by processing record values of the coordinate points in the memory space according to the record values of the nodes and the record values of the connection points. For examples, calculate the colored area by calculating the sum of the record values when the record values are a specific value (such as logic value 1). The process method is to start the processing from each coordinate point of the first row of the memory, then move to process the second row, followed by processing the third row. At the same time, when processing each row, the process follows a left to right order on each coordinate. In the FIG. 6, the steps of the method performed on each row are started from step S610, then move to step S620 to determine if record value of the current coordinate point is a flag value. If true, then the method moves to step S630 to start coloring (or starting when the record value of the coordinate point is 1). The process method is to start the processing from each coordinate point of the first row of the memory, then move to process the second row, followed by processing the third row. At the same time, when processing each row, the process follows a left to right order on each row. In the FIG. 6, the steps of the method performed on each row are started from step S610, then move to step S620 to determine if record value of the current coordinate point is a flag value. If true, then the method moves to step S630 to start coloring (coloring can be implemented, for example, by continuously assigning logic value 1 to the record value of the current coordinate point). The processing of coloring (namely, assigning logic value 1 to the record value) continues till another flag value is found in the remaining coordinate points of the same row. When coloring is stopped, logic value 1 is no longer assigned to the successive coordinate points for the same row.

Then the process moves back to step S610 to start again. On the other hand, if none of the record value of the remaining coordinate points of the same row is flag value, then the method moves to step S640 to determine if it is the end of the row processing. If yes, then the method moves to step S650 to terminate the row processing. If not, then the method returns to step S610 to start again. Accordingly, as all the coordinate points by each row in the memory are processed, the area of the polygon is calculated by summarizing the total quantity of colored coordinate points in all columns. The flow of processing values of the polygon according to the present invention can be expressed in the following program language (NC is the width of the memory space and NR is the length of the memory space):

```
for(j:=0;j< NR;j++)
{
  DRAW_FLAG := 0;
  for(i:=0;i<NC;i++)
  {
    if(Pattern[i][j] == FLAG)
    {
      DRAW_FLAG := abs(DRAW_FLAG −1);
    }
    if(DRAW_FLAG == 1 AND Pattern[i][j] == 0)
    {
      Pattern[i][j] = DRAW;
    }
  }
}
```

As mentioned above, FIG. 7 to FIG. 11 are perspective views of embodiments, which illustrate the method of fast coloring a polygon according to the present invention. The nodes are connected according to the order of the numbers. The colored area is calculated by following the method of fast coloring a polygon according to the present invention.

As the skilled person will appreciate, various changes and modifications can be made to the described embodiments. It is intended to include all such variations, modifications and equivalents which fall within the scope of the invention, as defined in the accompanying claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a flow chart of the method of fast coloring a polygon according to the present invention;

FIG. 2 is a flow chart of assigning a record value of each of the nodes as a flag value or a line value according to the present invention;

FIG. 3 is a flow chart of assigning a record value of each of the connection points between two nodes as a flag value or a line value according to the present invention;

FIG. 4 is a perspective view illustrating assigning a record value of each of the connection points as a flag value or a line value according to an embodiment of the present invention;

FIG. 5 is a perspective view illustrating assigning a record value of each of the connection points as a flag value or a line value according to another embodiment of the present invention;

FIG. 6 is a flow chart of processing the record values of a row of the polygon according to the present invention;

FIG. 7 is a perspective view illustrating the method of fast coloring a polygon according to an embodiment of the present invention;

FIG. 8 is a perspective view illustrating the method of fast coloring a polygon according to an embodiment of the present invention;

FIG. 9 is a perspective view illustrating the method of fast coloring a polygon according to an embodiment of the present invention;

FIG. 10 is a perspective view illustrating the method of fast coloring a polygon according to an embodiment of the present invention;

FIG. 11 is a perspective view illustrating the method of fast coloring a polygon according to an embodiment of the present invention; and

FIG. 12 is a perspective view illustrating the memory space according to the present invention

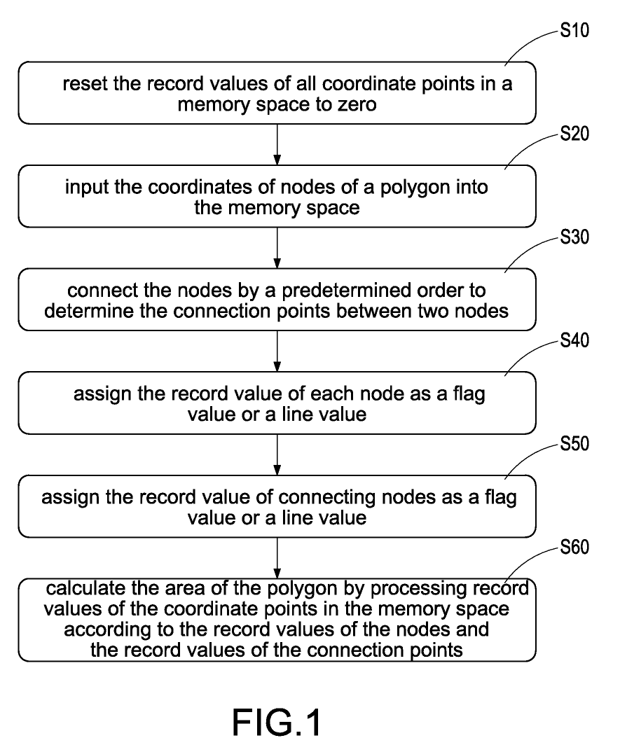

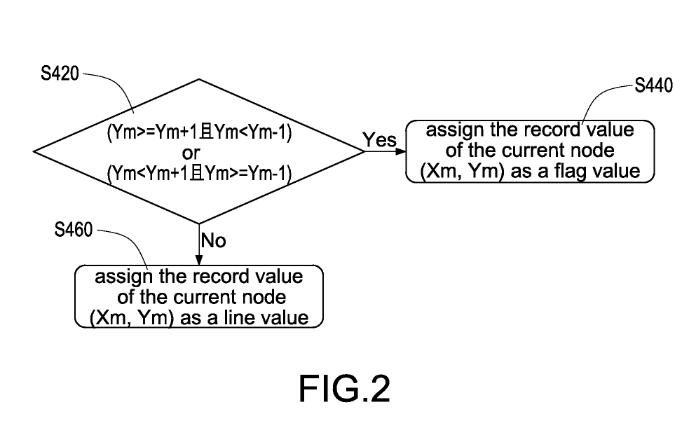

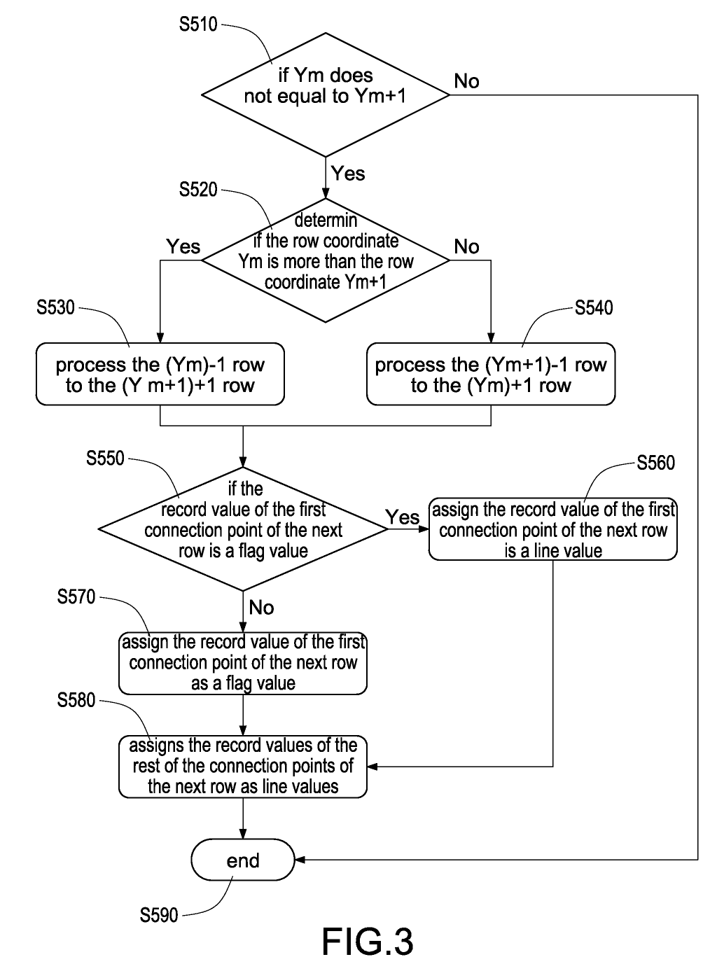

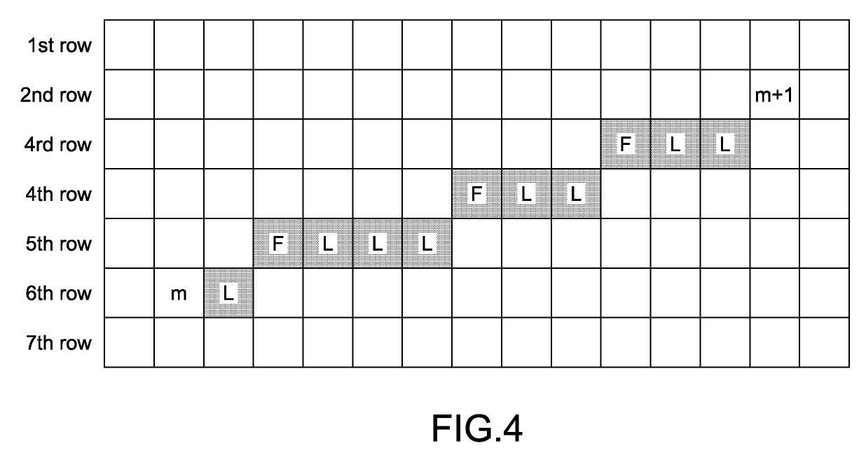

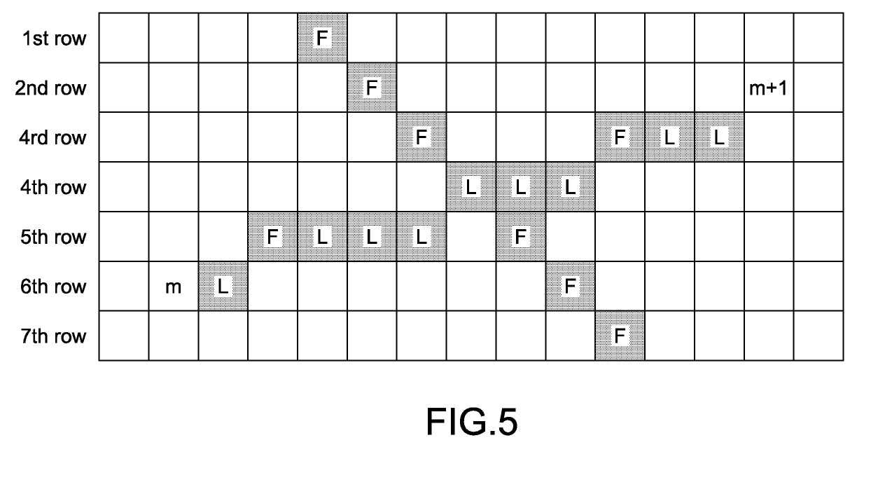

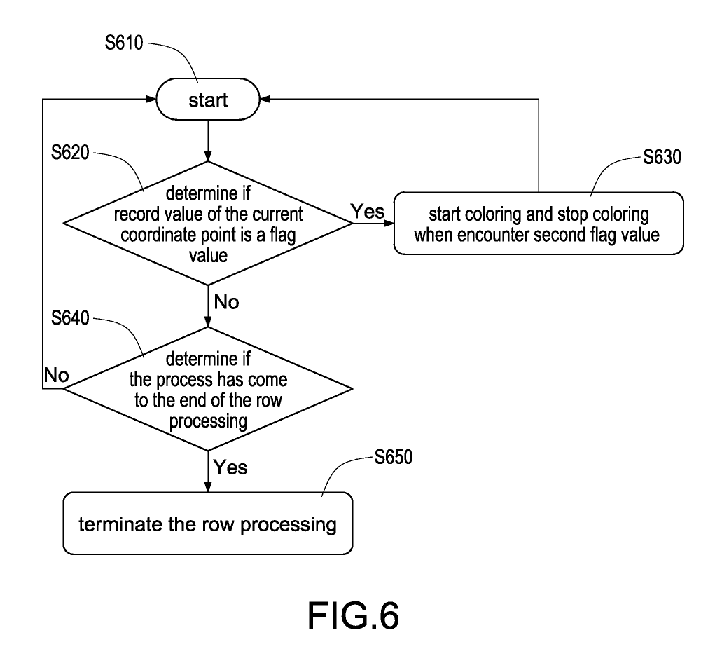

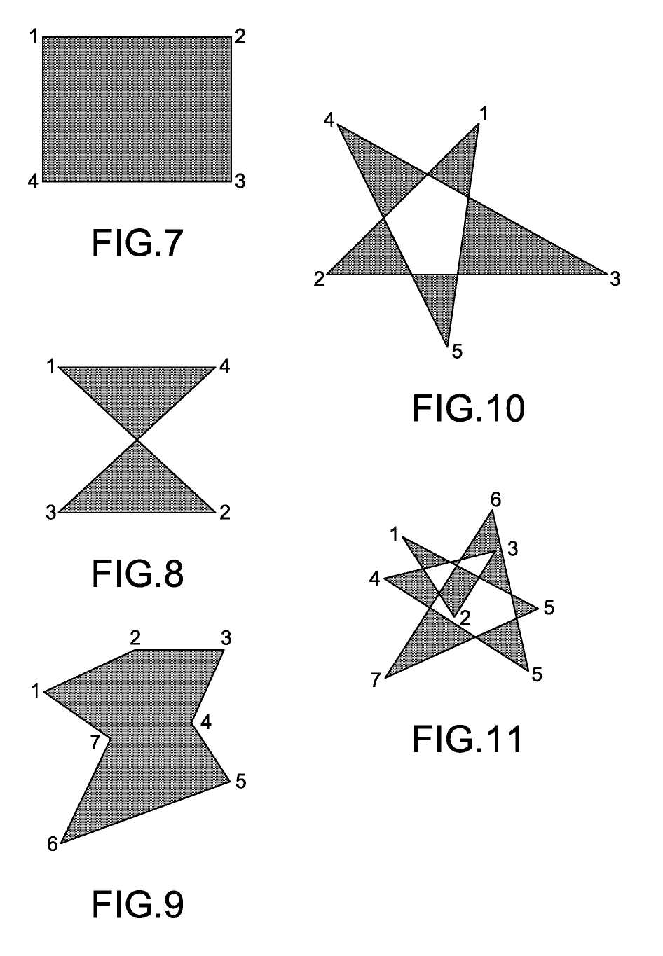

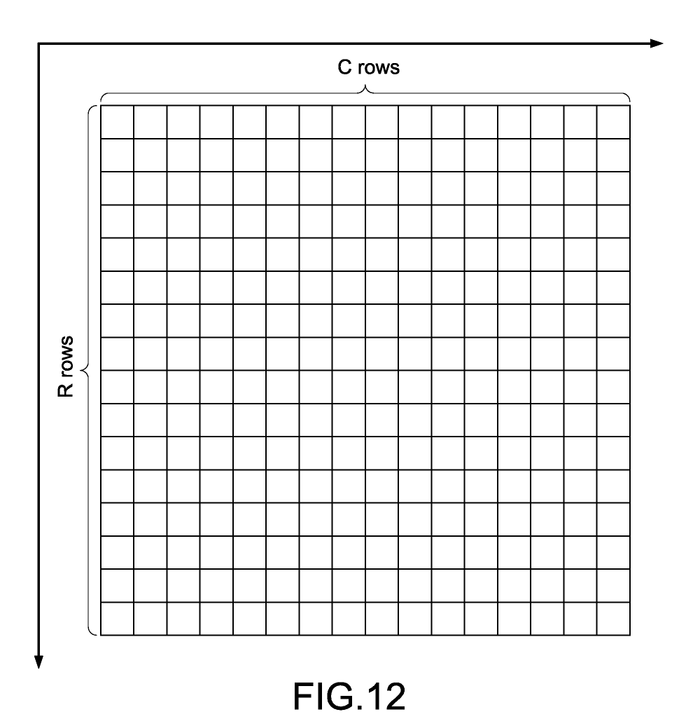

What is claimed is:

1. A method of fast coloring a polygon used in a memory space for calculating an area of the polygon in the memory space, wherein the memory space comprises a plurality of coordinate points matrix in an X-Y coordinate system, the polygon is defined by a plurality of ordered nodes, said method comprising:
(A) resetting record values of all coordinate points to zero in said memory space;
(B) inputting the coordinates of said ordered nodes defining said polygon into the memory space;
(C) connecting said nodes according to a predetermined order to determine connection points between said nodes;
(D) assigning a record value of each said node as a flag value or a line value;
(E) assigning a record value of said connection points as a flag value or a line value; and
(F) calculating said area of said polygon by processing record values of said coordinate points in said memory space according to said record values of said nodes and said record values of said connection points.

2. The method of fast coloring a polygon of claim 1, wherein said step (D) further comprises:
(D1) assigning a flag value to the record value of the current node if the Y coordinate value of the current node is not less than the Y coordinate value of the next node and Y coordinate value of the current node is less than the Y coordinate value of the previous node.

3. The method of fast coloring a polygon of claim 2, wherein said step (D) further comprises:
(D2) assigning a flag value to the record value of the current node if the Y coordinate value of the current node is less than the Y coordinate value of the next node and Y coordinate value of the current node is not less than the Y coordinate value of the previous node.

4. The method of fast coloring a polygon of claim 3, wherein said step (D) further comprises:
(D3) assigning a line value to the record value of the current node which is not assigned a flag value.

5. The method of fast coloring a polygon of claim 4, wherein said step (E) further comprises:
(E1) processing the connection point between two nodes by rows; and
(E2) assigning a flag value to the first connection point if the record value of the first connection point of the following row is not a flag value.

6. The method of fast coloring a polygon of claim 5, wherein said step (E) further comprises:
(E3) assigning a line value to the first connection point if the record value of the first connection point of the following row is a flag value.

7. The method of fast coloring a polygon of claim 6, wherein at said step (F) the process order follows an order of from left to right and from top to bottom, and said step (F) further comprises:
(F1) initiating coloring if the record value of a connection point of said processing row is a flag value, and stop coloring if the record value of the following connection point is also a flag value.

8. The method of fast coloring a polygon of claim 7, wherein said step (F) further comprises:
(F2) determining the ending point of said processing row if the record values of the coordinate points of said processing row are not flag values; and
(F3) terminating processing of the processing row if processing the end point of said processing row.

9. The method of fast coloring a polygon of claim 8, wherein said step (F) further comprises:
(F4) calculate said area of said polygon by summarizing the total quantity of specific record values of coordinate points in said memory space.

10. The method of fast coloring a polygon of claim 9, wherein said specific record values are record values corresponding to logic value 1
